(19) United States
(12) Patent Application Publication
(10) Pub. No.: US 2004/0268230 A1
(43) Pub. Date: Dec. 30, 2004

(54) Systems and methods for differential document delivery based on delta description specifications

(76) Inventors: Peiya Liu, East Brunswick, NJ (US); Liang H. Hsu, West Windsor, NJ (US)

Correspondence Address: Siemens Corporation, Intellectual Property Department, 170 Wood Avenue South, Iselin, NJ, 08830, US

(21) Appl. No.: 10/610,442

(22) Filed: Jun. 30, 2003

(51) Int. Cl. G06F 15/00

(52) U.S. Cl. 715/511

(57) ABSTRACT

Systems, methods and applications for updating or otherwise modifying documents, post delivery, by distributing difference documents over a network for document delivery. The difference documents include content difference specifications and/or presentation difference specifications, as described using a formal delta (or difference) description specification. Preferably, the difference specifications comprise a sequence of labeled and conditional XML content and presentation difference descriptions that enable a presentation document to be directly update without having to actually modify the source document(s) associated with the presentation document.

### TECHNICAL FIELD OF THE INVENTION

The present invention relates generally to systems, methods and applications for document distribution and processing. The invention further relates to systems, methods and applications for updating or otherwise modifying documents, post delivery, by distributing difference documents over a network for document delivery, wherein the difference documents include content difference specifications and/or presentation difference specifications as described using a formal delta (or difference) description specification.

### BACKGROUND

In general, it is important for document distribution applications to deliver “information differences” (relative to baseline documents) in an efficient manner. Such information differences to distributed baseline documents include, for example, information that provides updates, enhancements, temporary add-ons, etc. Indeed, systems and methods for providing automated and efficient delivery of difference document information for document updates/enhancements are highly desirable for effective post delivery services, especially in heavy industries.

Traditional “update-and-distribute” methods for differential document delivery are limited. Such methods cannot be used for certain applications and are not cost-effective for merging differences into baseline documents beforehand for delivering complete documents to customers. For instance, update-and-distribute methods cannot be used for updating the post-delivery CD (compact disc) documents or adding additional links on read-only CD media. Moreover, update-and-distribute methods are not cost-effective for simultaneously distributing large variations of the same core documents, since there are many duplicating document information are required.

The development of open standards such as XML (extensible Markup Language) has led to more efficient and effective methods for document processing, wherein the documentation process can be automated in many areas in document lifecycle.

As is known in the art, XML is an extensible text format standard, which has been developed for use with large-scale electronic publishing and network exchange of various types of data, for example. XML allows authors and providers to design their own document markup (see, e.g., XML Extensible Markup Language (XML) 1.0 (Second Edition) W3C Recommendation 6 Oct. 2000).

Accordingly, given the increasing popularity and ubiquity of XML for, e.g., web-based application environments, it would be highly desirable to develop an extensible differential document delivery system and method based on XML.

### SUMMARY OF THE INVENTION

The present invention relates generally to systems, methods and applications for document distribution and processing. The invention further relates to systems, methods and applications for updating or otherwise modifying documents, post delivery, by distributing difference documents over a network for document delivery, wherein the difference documents include content difference specifications and/or presentation difference specifications, as described using a formal delta (or difference) description specification. Preferably, the difference specifications comprise a sequence of labeled and conditional XML content and presentation difference descriptions.

In one embodiment of the invention, a method for updating documents comprises: obtaining a difference document that describes difference specifications for modifying a presentation document; identifying a component of the presentation document using the difference specifications and a source document corresponding to the presentation document; and modifying the identified component of the presentation document based on the difference specifications.

In a preferred embodiment, the process of identifying components of the presentation document comprise connecting the source and the presentation documents using a marking method (or connection scheme) to perform a “virtual merge” process, wherein elements in the presentation document are marked by element IDs with XML tag names and document order appearing in the source document. This virtual merge process enables elements in the presentation document, which correspond to the focus nodes of the source documents, to be identified/located and then directly updated based on the difference specifications, without actually having to modify source documents.

The difference specifications are preferably defined using XML syntax and an XML grammar and the difference specifications preferably comprise a sequence of voice-enabled and conditional difference descriptions. The difference specifications may describe content differences, presentation differences, or a combination thereof. Document modification may comprise a document update, a document enhancement, a document personalization, or a temporary modification.

These and other embodiments, aspects, objects, features and advantages of the present invention will be described or become apparent from the following detailed description of preferred embodiments, which is to be read in connection with the accompanying drawings.

### BRIEF DESCRIPTION OF DRAWINGS

FIG. 1 is a block diagram illustrating a system for providing differential document delivery based on difference specifications, according to an embodiment of the present invention.

FIG. 2 is a diagram that graphically illustrates functions of a DocUpdate Plug-in of FIG. 1, according to an embodiment of the present invention.

FIG. 3 is a flow diagram illustrating method for updating a presentation document according to an embodiment of the present invention.

FIG. 4 illustrates a method for connecting source and presentation documents according to an embodiment of the invention.

FIG. 5 is an exemplary XML DTD (document type definition) of a DLL (Delta Description Language) for specifying differences, according to an embodiment of the invention.

FIG. 6 illustrates exemplary difference specifications for changing a tile of a figure of a presentation document based on the exemplary grammar of FIG. 5.

FIG. 7 illustrates exemplary difference specifications for performing a text content update of a presentation document based on the exemplary grammar of FIG. 5.

FIG. 8 illustrates exemplary difference specifications for performing a graphics content update of a presentation document based on the exemplary grammar of FIG. 5.

FIG. 9 illustrates exemplary difference specifications for adding links to supplement information in a presentation document, based on the exemplary grammar of FIG. 5.

### DETAILED DESCRIPTION OF PREFERRED EMBODIMENTS

The present invention relates generally to systems, methods and applications for document distribution and processing. The invention further relates to systems, methods and applications for updating or otherwise modifying documents, post delivery, by distributing difference documents over a network for document delivery, wherein the difference documents include content difference specifications and/or presentation difference specifications, as described using a formal delta (or difference) description specification. Preferably, the difference specifications comprise a sequence of labeled and conditional XML content and presentation difference descriptions. Advantageously, systems and methods according to the invention can be used to present updated web documents on-the-fly based on difference description specifications without having to physically merge documents before distribution and without having to modify source documents.

It is to be understood that the systems and methods described herein in accordance with the present invention may be implemented in various forms of hardware, software, firmware, special purpose processors, or a combination thereof. Preferably, the present invention is implemented in software as an application comprising program instructions that are tangibly embodied on one or more program storage devices (e.g., hard disk, magnetic floppy disk, RAM, CD ROM, ROM and Flash memory), and executable by any device or machine comprising suitable architecture.

It is to be further understood that since the constituent system modules and method steps depicted in the accompanying Figures are preferably implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

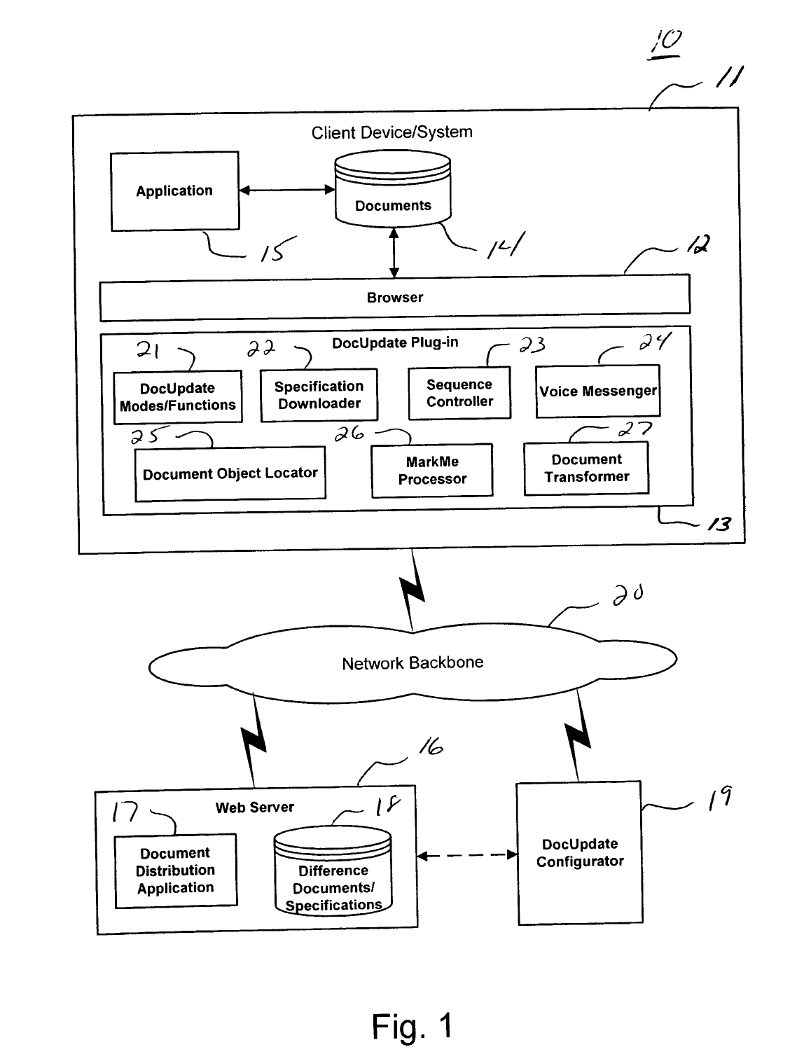

Referring now to FIG. 1, a block diagram illustrates a system for providing differential document delivery based on difference specifications, according to an embodiment of the present invention. In general, the system (10) comprises a client device (11) (e.g., workstation, laptop computer, PDA, mobile phone, etc.) comprising a conventional web browser application (12) and an associated browser plug-in (13) (or alternatively referred to herein as DocUpdate Plug-in). The DocUpdate Plug-in module (13) enhances the functionality of the web browser (12) by providing additional functionalities and operational modes that enable modification/update/enhancement of identifiable objects in documents (14), which are associated with a client application (15), based on difference documents or difference specifications that are obtained from web server (16) over a communications network (20) (e.g., Internet, LAN, WAN, PSTN, wireless, etc, or a combination thereof). The functions of the DocUpdate Plug-in module (13) are integrated into an HTML file (user interface), for example, being presented to the user.

The web server (16) (which is alternatively referred to herein as DocUpdate Server) comprises a document distribution application (17) for generating difference documents (or difference specifications) that are maintained in database (18). As explained in further detail below, an XML-based DLL (delta description language) according to the invention is used for describing difference specifications for document updates/enhancements/modification, which specifications comprise sequences of voice-enabled and conditional difference descriptions specifying content and/or presentation differences.

A DocUpdate Configurator module (19) manages the DocUpdate Server (16) and provides notification of the location of the DocUpdate Server (16) and posted difference specifications. As shown, the DocUpdate Configurator module (19) may be a local or remote system with respect to the web server (16).

As noted above, the DocUpdate Plug-in module (13) comprises a plurality of components/modules (21-27) which, as noted above, enable post delivery updates, enhancements, and/or modifications of identifiable objects of the application documents (14) using difference documents (18) downloaded from web server (16). The difference documents may comprise difference specifications that describe: (i) text, graphics, and/or link updates of the documents (14) to provide post-delivery data services; (ii) enhancements such as prefixed links to web pages from post delivered documents; (iii) personalization (e.g., variations of the same core document for simultaneous distribution); and/or (iv) temporary updates (e.g., seasoning information).

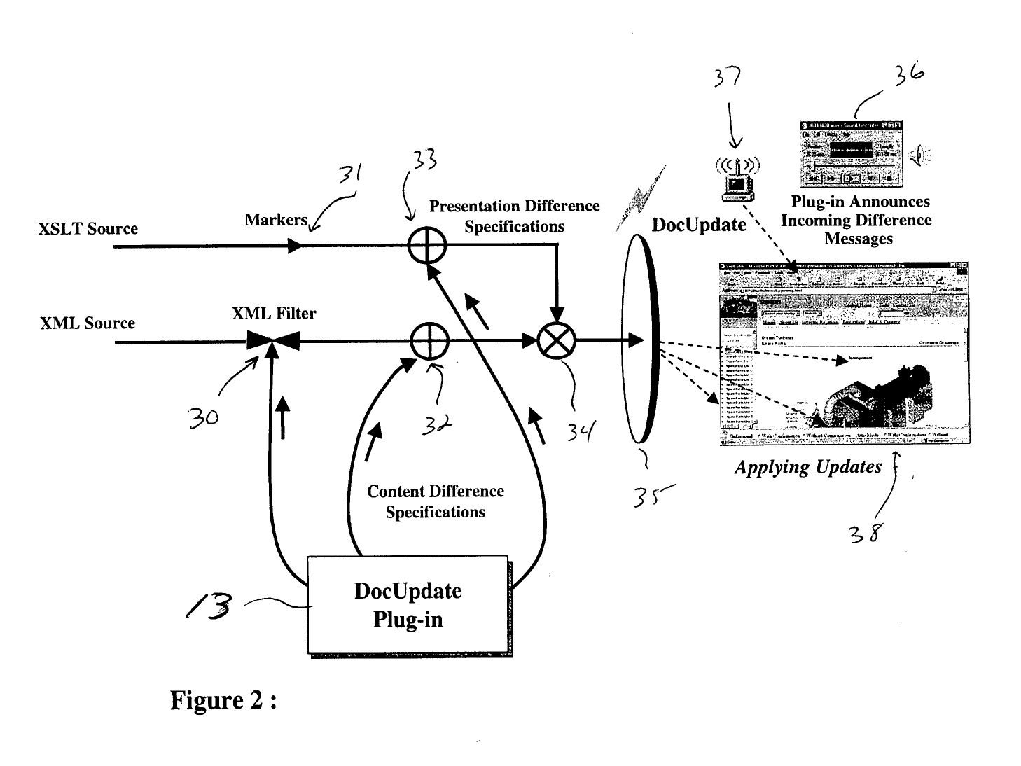

More specifically, the DocUpdate Plug-in (13) comprises a DocUpdate modes/function module (21) that enhances the user interface (e.g., GUI) of the browser application (12) to provide buttons or other means for selecting update functions. For instance, the user interface (UI) may comprise a “DocUpdate Button” (see, e.g., element (37), FIG. 2) that a user can select to commence a document update process for a displayed presentation document. In addition, the browser UI may comprise a plurality of buttons that enables the user to select from one of a plurality of modes of operation for updates. For example, in one embodiment of the invention, the DocUpdate modes/function module (21) enables user-selection of the following modes of operation inside the web browser (12):

(1) On-Demand With Confirmation—this mode of operation allows an end-user to click the “DocUpdate Button” to obtain updates of a currently displayed page, wherein confirmation of the update is requested prior to updating;

(2) On-demand Without Confirmation—this mode of operation allows an end-user to click the “DocUpdate Button” to obtain updates on a currently display page, but does not require user confirmation prior to update;

(3) Auto Without Confirmation—this mode of operation allows a currently selected page to be automatically updated upon loading the page, without a request or confirmation from the user;

(4) Auto With Confirmation—this mode of operation is similar to (3) above, but user confirmation is requested prior to updating the currently selected page.

Furthermore, the DocUpdate Plug-in module (13) comprises a specification downloader (22), a sequence controller (23), a voice messenger (24), a document object locator (25), a marker (or MarkMe) processor (26) and a document transformer module (27). In general, specification downloader module (22) performs functions such as obtaining difference specifications and associated files from the web server (16). The sequence controller (23) performs functions such as parsing and interpreting the difference documents that are described using a DLL (delta description language). The voice messenger module (24) provides voice announcement of incoming difference messages. The document object locator module (25) performs on-the-fly document object locating to identify corresponding elements in a presentation document based on the difference specifications. The document object locator module (25) uses the marker processor (26) for connecting (associating) corresponding elements of presentation documents and source documents. The document transformer (27) performs on-the-fly difference transformation operations for the presentation page based on the difference specifications. Preferred functions and modes of operation of the DocUpdate Plug-in module (13) will be explained in further detail below with reference to FIGS. 2, 3 and 4.

FIG. 2 is a diagram that graphically illustrates functions of the DocUpdate Plug-in (13) of FIG. 1, according to an embodiment of the present invention. In general, the DocUpdate Plug-in (13) obtains a difference document (difference specifications) and associated files including a presentation source (e.g., XSLT source) and a content source document (e.g., XML source) that are associated with a presentation document.

The elements of the presentation source (e.g., XSLT source) comprise Markers (31) are special element IDs with XML tag names and document order appearing in the corresponding content source document (e.g., XML source document). The DocUpdate Plug-in (13) filters the XML source document (via XML Filter process (30)) to select focus nodes of the source document that have update information, as specified in the difference specifications.

The difference specifications are described using an XML-based DLL (delta description language). In one preferred embodiment of the invention, the difference specifications for document updates comprise sequences of voice-enabled and conditional difference descriptions of content differences and presentation differences on XML document objects.

The DocUpdate Plug-in (13) parses the downloaded difference document to separate the content difference specifications and the presentation difference specifications, if any, that are specified in the difference document.

The “conditions” that are described by the content difference specifications are compared (via process (32)) against the selected focus nodes of the XML source (as determined by XML filter (30)) to determine if the node condition is satisfied, i.e., determine if the content of the node is to be updated in the presentation document in accordance with the content difference specification.

Similarly, the “conditions” that are described by the presentation difference specifications are compared (via process (33)) against the corresponding focus nodes in the presentation source document (as determined via the Markers (31)) to determine if the node condition is satisfied, i.e., determine if the presentation (structure and/or formatting) of the corresponding focus node is to be updated in the presentation document in accordance with the presentation difference specification.

In accordance with the invention, the XSLT source and XML source documents are read-only documents and are not updated directly. Therefore, a virtual merge operation (34) is performed for updating a presentation document in accordance with the content and/or presentation difference specifications for each focus node that satisfies the conditions of such difference specifications. The virtual merge process (34) locates the elements in the presentation document corresponding to the focus nodes of the source documents to be updated, and a document transformation process (35) is performed to update the presentation document. The updates are applied and the updated presentation page (38) is displayed via the browser.

As further depicted in FIG. 2, when a presentation page is displayed via the UI of the browser, the user can click on the DocUpdate button (37) to receive updates for the presentation page that is currently displayed. When the conditions of the difference specifications for focus nodes are satisfied (as determined via processes (32) and (34)), a label of each difference description will be “read out” by, e.g., GUI (text message) or audio playback (36) to inform the user of the update and enable the user to confirm the update, depending on the selected mode of operation for updates (as explained above with reference to FIG. 1).

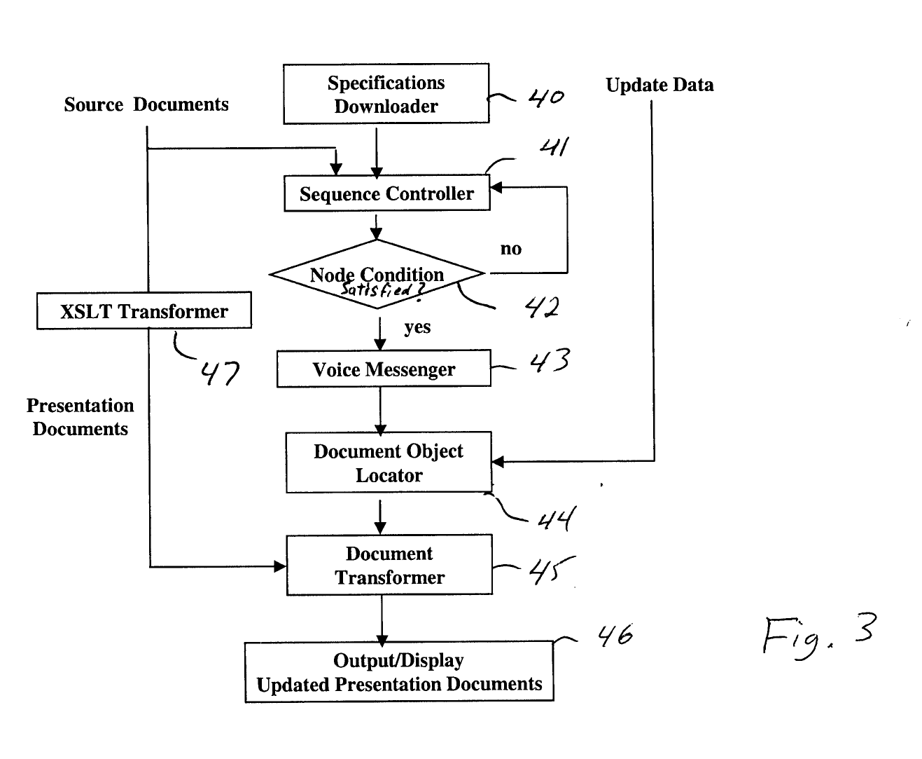

FIG. 3 is a flow diagram illustrating method for updating a presentation document according to an embodiment of the present invention. More specifically, FIG. 3 provides further details regarding operation of components (21-27) of the DocUpdate Plug-in (13) of FIG. 1 and an update process depicted in FIG. 2. In general, the method of FIG. 3 is performed by the DocUpdate Plug-in module (13) to perform on-the-fly document object locating and on-the-fly document transformation. Initially, a process is invoked (via the Specification Downloader (22)) to download difference specifications from the DocUpdate Server and obtain relevant source documents (e.g., XML source document(s) and XSLT source document(s)) associated with a presentation document (step 40).

Then, a process is invoked (via the Sequence Controller (23)) to decompose the difference specifications in the difference document into individual differences (step 41), to control the execution sequence of the difference specifications, and to monitor the node condition in each difference specification step (step 41). In particular, as described above with reference to FIG. 2, the “conditions” that are described by the difference specifications are processed against the focus nodes of the source documents to determine if the content and/or presentation of the corresponding focus nodes of the presentation document are to be updated in accordance with the presentation difference specifications.

If a node condition is satisfied (affirmative result in step 42), i.e., there is update information for the current presentation page, an incoming update message is announced (via audio playback) to the end-user via the Voice Messenger (24) module (step 43).

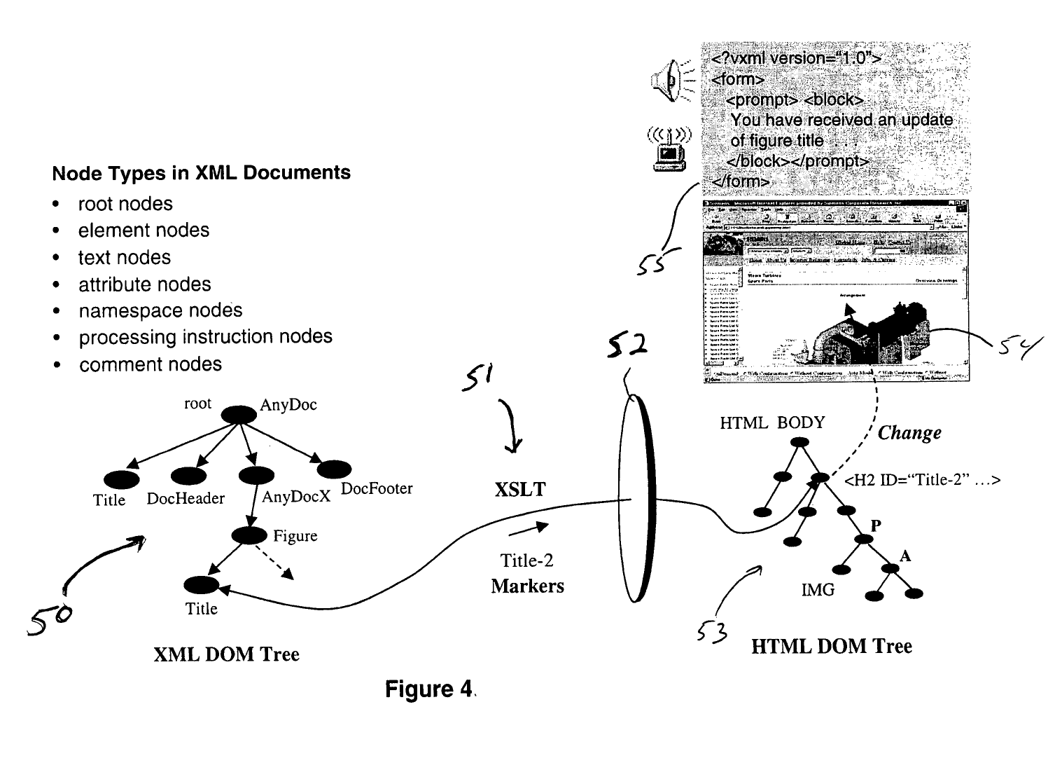

Then, a process is invoked (via the Document Object Locator (25)) to find the corresponding elements in the presentation document(s) that are to be updated based on the difference specifications (step 44). More specifically, the document object locating process (step 41) utilizes a marking method (or connection scheme) (via the MarkMe processor (26)) to perform a virtual merge process to identify/locate elements in the presentation document that correspond to the focus nodes of the source documents to be updated. The document object locator process (step 44) receives “update data”, e.g., “update” files (such as graphic files) that are specified in difference specifications. Details regarding a preferred connection scheme are described in further detail below with reference to FIG. 4.

A presentation document is generated “on-the-fly” by processing the source documents (e.g., XML and XSLT source) via a transformation process (step 47), which is preferably performed by a XSLT transformer of the browser. More specifically, the presentation document denotes an HTML document that is dynamically generated from XML/XSLT source documents using a XSLT transformer of the browser and which is displayed in the browser.

The presentation document is input to a document transformation process (step 45) which updates the presentation document based on the difference specifications. More specifically, once the corresponding nodes of the source documents and presentation document are “connected” (via the document object location process (step 44), the specified update operations are performed (via the Document Transformer(27)) to transform the presentation document as specified by the applicable difference specifications, and the updated presentation document(s) is output, rendered and displayed (step 46).

FIG. 4 illustrates a method for connecting source and presentation documents according to an embodiment of the invention. As noted above, the method of FIG. 4 depicts a function of the MarkMe processor (26) (FIG. 1), which is preferably used by the Document Object Locator (25) (in step 44, FIG. 3) to locate and connect corresponding elements in presentation documents. In FIG. 3, the source documents (XML/XSLT sources) that are processed (in step 44) by the Document Object Locator are read-only documents and are not directly updated. Accordingly, as noted above, a “virtual merging” method is implemented for updating presentation documents.

The presentation document update process employs a “connection” scheme to automatically identify elements of the presentation document (which are to be updated) based on the element tag names differences between the source and presentation documents. The method depicted in FIG. 4 performs such connection process according to an embodiment of the invention. More specifically, in the exemplary embodiment of FIG. 4, a XML source document is depicted as an XML DOM tree of nodes (50). As in known in the art, a parsed XML source document can be represented/modeled as a tree structure that comprises various nodes. Such nodes include root nodes, element nodes, text nodes, attribute nodes, namespace nodes, processing instruction nodes, and comment nodes. Using DOM (Document Object Model), for example, the nodes of the tree (50) comprise objects and a DOM API is used to control, access and traverse the node hierarchy of the XML tree nodes/elements that are exposed as objects.

Furthermore, by modeling XML document (50) as a tree of nodes, the XPath protocol can be used to address parts of the XML document. As is known in the art, XPath is an addressing mechanism that can be used to identify parts of an XML document. XSLT uses XPath for selecting nodes in the XML tree (50).

In FIG. 4, elements of a presentation document (53) (which is depicted as an HTML DOM tree) are marked (via marking process (52)) by element IDs with XML tag names and document order appearing in the source document (50). The special element IDs are referred to as Markers in FIG. 2. In other words, XSLT (51) is used to dynamically mark XML tags in HTML tags. In addition, the numbering scheme on “MarkMe” IDs are preferably based on document order (hierarchical position of components in the tree) (or in other contexts other than XPath, “parse order” or “depth-first order”) and tag names. For instance, as depicted in FIG. 4, the “title” element (tag name) in the XML DOM tree (50) is connected to the “H2” element of the HTML DOM tree (53) by marking (via process 52) the “H2” element with marker “ID=Title-2” in accordance with XSLT (51).

More specifically, the exemplary diagram of FIG. 4 depicts a circumstance in which an update is received for a “title” of the displayed figure (54), which update is audibly announced by rendering the markup (55). In accordance with the invention, difference specifications refer only to elements in source documents. In the exemplary embodiment, assume that the content of title <title>xx</title> in the source document (50) is to be changed to “yy” (as specified by the difference specifications). Assume further that the corresponding element in the HTML presentation document (53) (which, as noted above, is internally generated by an XSLT transformer of the browser) is in the form of <H2>xx</H2>. In other words, the “title” element of the source document (50) corresponds to element “H2” of the presentation document (53) (wherein “H2” means “display in header2 bold face” for xx). However, since the difference specifications preferably refer only to elements in source documents, the presentation document (53) cannot be updated without a “connection” to the source document (50).

Therefore, in accordance with the invention, the marking process (MarkMe process) is invoked to transform the markup <H2>xx</H2> into <H2 ID=“title-No”>xx</H2> by designing “makers” in XSLT. The No (number) is preferably based on the order of appearance of the <title> element in the XML source document (50). Using such markers, the <title> element in the XML source document (50) can be connected (associated) with the corresponding element in the HTML presentation document (53) as follows H2: <H2 ID=“title-2”>xx</H2>. In this way, the content of the presentation document (53) can readily updated from “xx” to “yy” as specified by the delta descriptions.

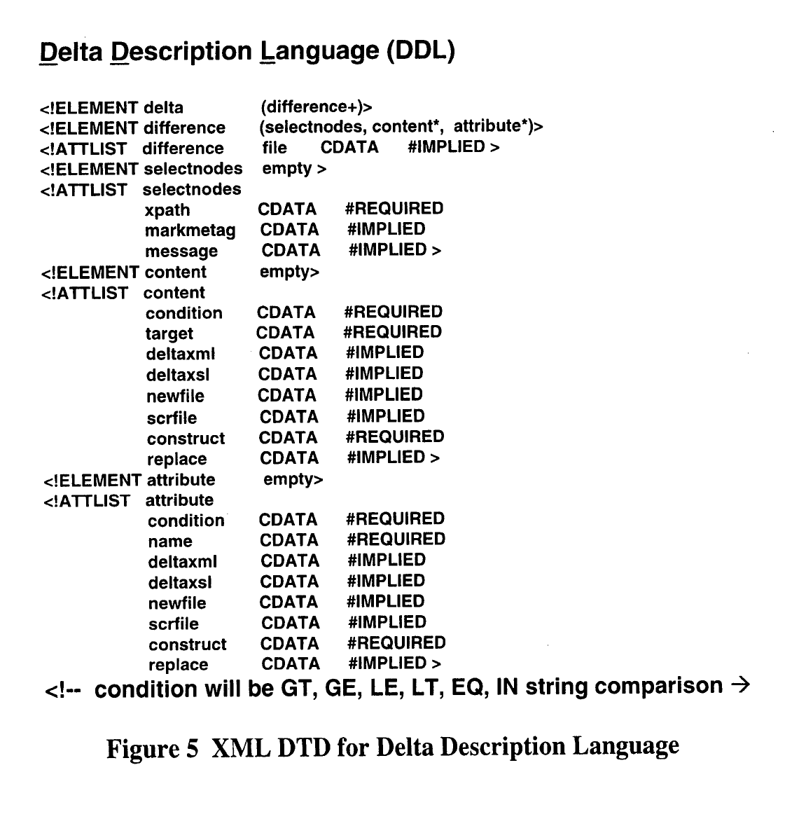

In accordance with the present invention, a DLL (Delta Description Language) comprises a formal XML-based specification language for describing difference specifications. FIG. 5 is an exemplary XML DTD (document type definition) of a DLL according to the invention. As is known in the art, the document type definition (DTD) is a method that is used to define a markup language. A DTD (or grammar) is used to specify a content model for each element, wherein the content description is part of the element declaration in the DTD and specifies the order and quantity of elements that can be contained within the element being declared. A DTD can be inserted within a doctype declaration (internal DTD) or stored as a separate file with the extension “.dtd” and pointed to in an XML file. The XML DTD can either be in the prolog of the XML template or it can be in a sepearate file that is referred to in the prolog.

In FIG. 5, the “ELEMENT” declarations identify the names of elements and the nature of the content (content model) of such elements. The ATTLIST declarations identify which elements may have attributes, and specify the name, data type and default value (if any) of each attribute associated with a given element type.

For example, an ELEMENT declaration is specified for an element named delta, which represents a root element for a difference document and which comprises a content model that specifies a child element difference. Preferably, the difference specifications in an XML-based difference document comprise a sequence of difference descriptions described by the difference element (the+character specifies that element difference may be repeated more than once but it must occur once).

Each difference description preferably comprises four parts: file, selectnodes, content and attribute. More specifically, an ELEMENT declaration for the element difference specifies a content model that includes elements selectnodes, content and attribute, wherein the wherein the comma “, ” between the elements indicates that the elements must occur once in the order declared and the * indicates that there can be zero or more of such elements. In addition, an ATTLIST declaration for element difference specifies a file attribute, which is a string-type attribute (CDATA) with a default value #IMPLIED. The file attribute is an optional description that can be used to specify a specific file to which the difference description applies.

An ELEMENT declaration for element selectnodes, specifies an EMPTY content model. A selectnodes element, which is alternatively referred to herein as XML filters (FIG. 2), specifies focus nodes of source documents that have update information. An ATTLIST declaration for element selectnodes specifies three attributes, xpath, markmetag and message. The xpath attribute, which is a string-type attribute (CDATA) with a default value #REQUIRED, is used to select focus nodes in source documents. The markemetag attribute, which is a string-type attribute (CDATA) with a default value #IMPLIED, is used for identifying the focus nodes in presentation documents. The message attribute, which is a string-type attribute (CDATA) with a default value #IMPLIED, is used to describe the characteristics of the update information.

An ELEMENT declaration for element contents specifies a content model EMPTY, and comprises a sequence content difference description. An ATTLIST declaration for the element content specifies multiple attributes, including condition, target, deltaxml, deltaxsl, newfile, srcfile, construct and replace.

The condition attribute, which is a string-type attribute (CDATA) with a default value #REQUIRED, is used to specify the detailed content conditions that are used to select nodes. Preferably, in such condition specification, the syntax “X##OP##Y” is used for string comparison, wherein X and Y are strings that may contain special string variables, and wherein OP specifies a comparison operator. In the exemplary embodiment, special string variable include $filename, which denotes a specific file value in each difference description, and $InnerHTML, $InnerText, $OuterHTML and $OuterText, which denote particular element string values of properties InnerHTML, InnerText, OuterHTML and OuterText, respectively, of current select nodes in a presentation document. Further, the OP comparison operator include, for example, EQ(equal), LE(less than or equal to), LT(less than), GT(greater than), GE(greater than or equal to), and IN(string inside).

The target attribute, which is a string-type attribute (CDATA) with a default value #REQUIRED, is used to specify the target content for update. The target attribute could be either variable $InnerHTML, $InnerText, $OuterHTML or $OuterText, for possible update to content of current selected nodes.

The deltaxml attribute, which is a string-type attribute (CDATA) with a default value #IMPLIED, is used to specify a XSLT file for content difference descriptions. The variable $deltaxml denotes the result of applying the XSLT file to the source documents.

The deltaxsl attribute, which is a string-type attribute (CDATA) with a default value #IMPLIED, is used to specify a XSL file for providing a presentation difference description. A variable $deltaxsl denotes the result of applying the changed XSLT file (by applying the specified XSL file to associated XSLT file in source documents) to source documents.

The newfile attribute, which is a string-type attribute (CDATA) with a default value #IMPLIED, is used to specify a file name which will be replaced by the scrfile specification in the update. The scrfile attribute, which is a string-type attribute (CDATA) with a default value #IMPLIED, is used to specify the new source file name, which may be located in a remote site. The variables $newfile and $scrfile are used to denote the values.

The construct and replace attributes, which are both string-type attribute (CDATA) with default values of #REQUIRED and #IMPLIED, respectively, are used to construct the final replacement string value for target value in two steps. The construct specification can use any of above special string variables in string construction. The replace specification is a sequence of a pair of old/new values for replacement of the constructed string.

An ELEMENT declaration for element attribute specifies a content model EMPTY, and comprises a sequence attribute difference specification. An ATTLIST declaration for the element attribute specifies multiple attributes for each attribute difference description, including condition, name, deltaxml, deltaxsl, newfile, srcfile, construct and replace. The attributes for the element attribute are the same as the attributes discussed above for the content element specification, except that the attributes for the element attribute include a name attribute (and do not include the target attribute of the content element specification). The name attribute, which is a string-type attribute (CDATA) with a default value #REQUIRED, is use to specify the attribute name for updating its value in presentation documents.

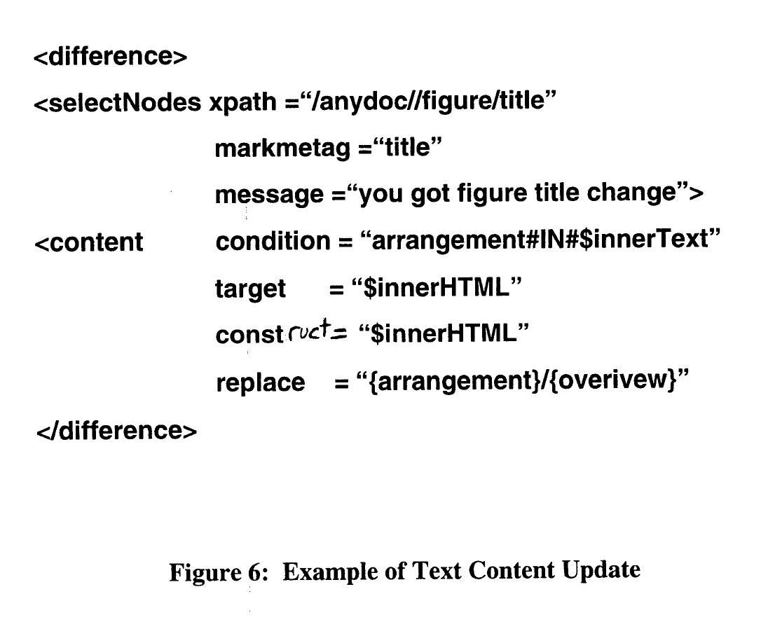

FIGS. 6, 7, 8 and 9 depict exemplary difference specifications for updating various components of presentation documents, which difference specifications are based on the grammar (DTD) depicted in FIG. 5. A brief description of these figures will now be provided, since details such exemplary difference specifications will be readily apparent to one of ordinary skill in art based on the teachings herein.

For example, FIG. 6 depicts an exemplary difference specification for changing the tile (text content update) of a Figure of a document. In particular, the difference specification of FIG. 6 specifies a text content update, wherein the text content is a figure title that changes from “arrangement” to “overview”.

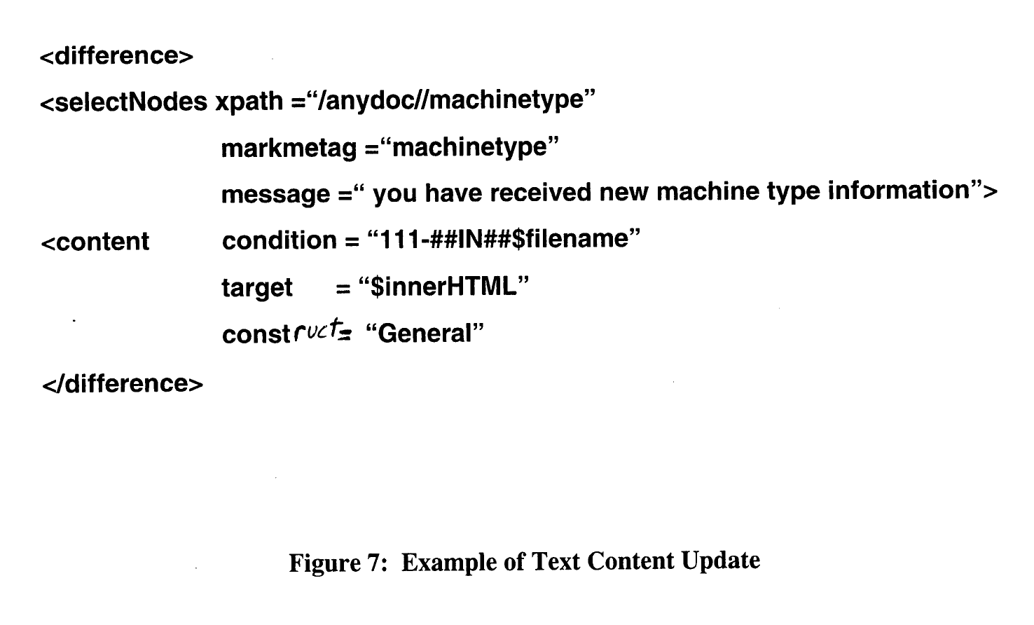

Further, FIG. 7 depicts another exemplary difference specification for text content update. More specifically, the difference specification specifies a text content add (general) to the content of a machinetype element in all source documents of a ill book.

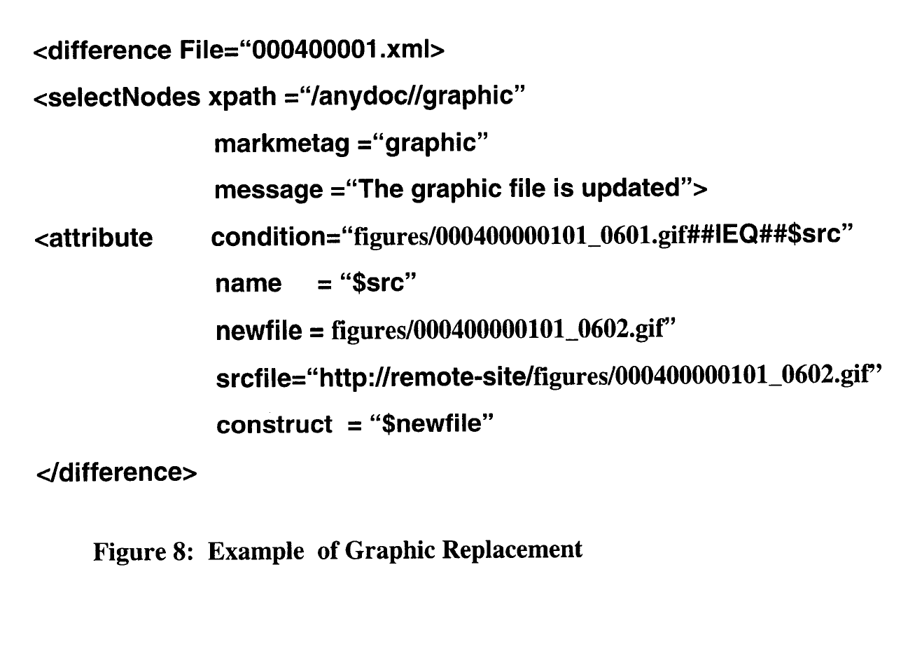

FIG. 8 depicts an exemplary difference specification for updating graphics content. In particular, FIG. 8 illustrates DLL specifications of graphic replacement via src attributes in presentation documents.

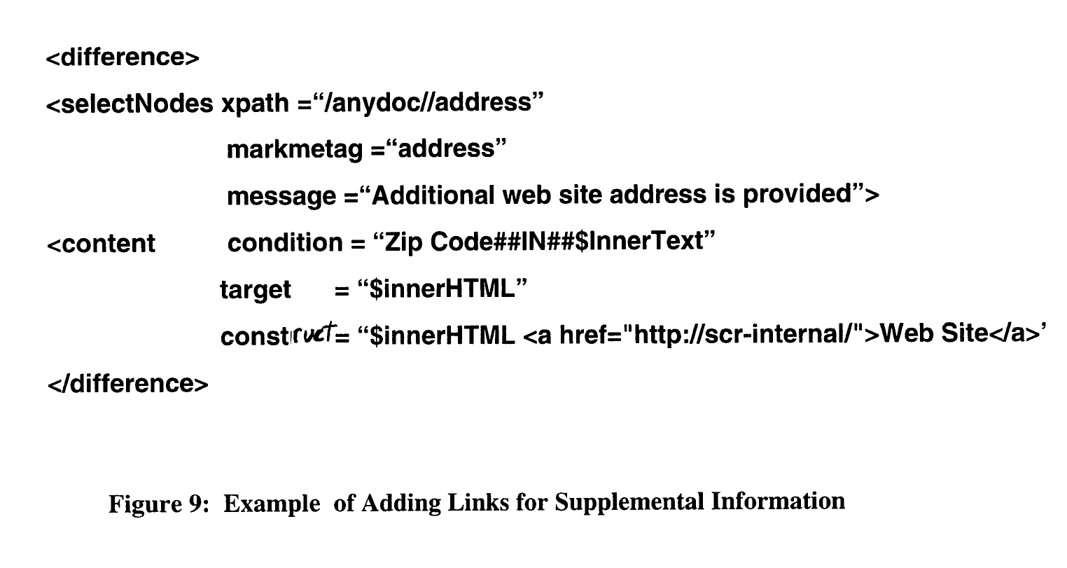

FIG. 9 depicts an exemplary difference specification for adding links to supplement information. In particular, FIG. 9 illustrates DLL difference specifications for adding an HTML link for supplemental information.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for updating documents, comprising the steps of:
obtaining a difference document that describes difference specifications for modifying a presentation document;
identifying a component of the presentation document using the difference specifications and a source document corresponding to the presentation document; and
modifying the identified component of the presentation document based on the difference specifications.

2. The method of claim 1, wherein the step of modifying is performed automatically upon loading the presentation document either with or without user confirmation.

3. The method of claim 1, wherein the step of modifying is performed on demand by a user, either with or without user confirmation.

4. The method of claim 1, wherein the method is performed by a plug-in for a browser application.

5. The method of claim 1, wherein the difference specification describes a content difference, a presentation difference, or both.

6. The method of claim 1, wherein the step of modifying comprises a document update, a document enhancement, a document personalization, or a temporary modification.

7. The method of claim 1, wherein the step of identifying a component of the presentation document comprises the steps of connecting the source and the presentation documents for performing on-the-fly document object locating, wherein elements in the presentation document are marked by element IDs with XML tag names and document order appearing in the source document.

8. The method of claim 1, wherein the step of obtaining the difference document comprises downloading the difference document from a local or remote repository of a server.

9. The method of claim 1, wherein the difference specifications are defined using XML syntax and an XML grammar.

10. The method of claim 9, wherein the difference specifications comprise a sequence of voice-enabled and conditional difference descriptions.

11. The method of claim 9, wherein a difference specification comprises a first element that specifies a node of a source document for which update information is provided.

12. The method of claim 11, wherein the first element comprises an attribute to select the focus nodes in the source document, an attribute to identify corresponding focus nodes in the presentation document, an attribute to describe the characteristics of update information, or a combination thereof.

13. The method of claim 9, wherein a difference specification comprises a second element that specifies a sequence content difference description.

14. The method of claim 13, wherein the second element comprises an attribute to specify a condition for modifying content of a focus node, an attribute to specify a target content for update, an attribute to specify a stylesheet for a content difference description, an attribute to specify a stylesheet for a presentation difference description, an attribute to specify a new source filename, an attribute to specify a filename to be replaced by the new source filename, and attribute to specify a construct of a replacement string for a target value, an attribute for replacing a constructed string, or a combination of the attributes.

15. The method of claim 14, wherein the attribute to specify a condition describes a string comparison comprising a syntax “X##OP##Y” for string comparison, wherein X and Y are strings and OP is a comparison operator.

16 The method of claim 15, wherein an X or Y string may comprise a string variable $filename to denote a specific file value described in the difference description, a string variable $InnerHTML, $InnerText, $OuterHTML or $OuterText to denote particular element string values of properties InnerHTML, InnerText, OuterHTML and OuterText of current selectnodes in the presentation documents.

17. The method of claim 15, wherein OP is one of EQ(equal), LE(less than or equal to), LT(less than), GT(greater than), GE(greater than or equal to), or IN(string inside)

18. The method of claim 14, wherein the attribute to specify a target may comprise a variable $InnerHTML, $InnerText, $OuterHTML or $OuterText for possible update to content of a currently selected node.

19. The method of claim 9, wherein a difference specification comprises a third element that specifies an attribute difference description.

20. The method of claim 19, wherein the third element comprises an attribute to specify a condition for modifying content of a focus node, an attribute to specify an attribute name for updating its value in the presentation document, an attribute to specify a stylesheet for a content difference description, an attribute to specify a stylesheet for a presentation difference description, an attribute to specify a new source filename, an attribute to specify a filename to be replaced by the new source filename, and attribute to specify a construct of a replacement string for a target value, an attribute for replacing a constructed string, or a combination of the attributes.

21. A program storage device readable by machine, tangibly embodying a program of instructions executable by the machine to perform method steps for updating documents, the method steps comprising:
obtaining a difference document that describes difference specifications for modifying a presentation document;
identifying a component of the presentation document using the difference specifications and a source document corresponding to the presentation document; and
modifying the identified component of the presentation document based on the difference specifications.

22. The program storage device of claim 21, wherein the instructions for modifying comprise instructions for automatically modifying upon loading the presentation document either with or without user confirmation.

23. The program storage device of claim 21, wherein the instructions for modifying comprise instructions for enabling modification on demand by a user, either with or without user confirmation.

24. The program storage device of claim 21, wherein the program instructions are part of a plug-in for a browser application.

25. The program storage device of claim 21, wherein the difference specification describes a content difference, a presentation difference, or both.

26. The program storage device of claim 21, wherein the instructions for modifying comprise instructions for performing a document update, a document enhancement, a document personalization, or a temporary modification.

27. The program storage device of claim 21, wherein the instructions for the step of identifying a component of the presentation document comprise instructions for the step of connecting the source and the presentation documents for performing on-the-fly document object locating, wherein elements in the presentation document are marked by element IDs with XML tag names and document order appearing in the source document.

28. The program storage device of claim 21, wherein the instructions for the step of obtaining the difference document comprise instructions for the step of downloading the difference document from a local or remote repository of a server.

29. The program storage device of claim 21, wherein the difference specifications are defined using XML syntax and an XML grammar.

30. The program storage device of claim 29, wherein the difference specifications comprise a sequence of voice-enabled and conditional difference descriptions.

31. A system for updating documents, comprising:
a browser application for viewing a presentation document, wherein the browser comprises a document update module comprising means for interpreting a difference document including difference specifications, and means for modifying the presentation document based on the difference specifications using a source document associated with the presentation document, without modifying the source document.

32. The system of claim 31, wherein the document update module further comprises means for obtaining a difference document from a web server.

32. The system of claim 31, wherein the document update module comprises:
means for identifying a component of the presentation document using the difference specifications and the source document corresponding to the presentation document; and
means for modifying the identified component of the presentation document based on the difference specifications.

33. The system of claim 32, wherein the document update module comprises means for connecting the source and presentation documents for on-the-fly document object locating, wherein elements in the presentation document are marked by element IDs with XML tag names and document order appearing in the source document.
